(19) United States
(12) Patent Application Publication
(10) Pub. No.: US 2016/0139449 A1
(43) Pub. Date: May 19, 2016

(54) GLUE FRAME AND DISPLAY DEVICE

(71) Applicant: Shenzhen China Str Optoelectronics Technology Co., Ltd., Shenzhen (CN)

(72) Inventor: Yanxue Zhang, Shenzhen (CN)

(21) Appl. No.: 14/425,884

(22) PCT Filed: Nov. 25, 2014
(86) PCT No.: PCT/CN2014/092185

§ 371 Date: Mar. 4, 2015

(30) Foreign Application Priority Data
Nov. 18, 2014 (CN) 201410660413.2

(51) Int. Cl. G02F 1/1333

(52) U.S. Cl. CPC G02F 1/133308; G02F 2001/133317

(57) ABSTRACT

A glue frame includes a first frame structure enclosed by a plurality of side walls, the first frame structure is injection molded integrally by the plastic cement and the metal sheet component. By applying the glue frame to a display device, the iron frame can be removed, thus saving the manufacturing costs, and improving the connection performance and the reliability.

### CROSS REFERENCE TO RELATED PATENT APPLICATIONS

This application claims the benefit under 35 U.S.C. Section 371, of PCT International Application No. PCT/CN2014/092185, filed Nov. 25, 2014, which claimed priority to Chinese Patent Application No. 201410660413.2, filed Nov. 18, 2014, the disclosures of which are hereby incorporated by the references.

### BACKGROUND OF THE INVENTION

1.Field of the Invention

The present invention relates to the technical field of display, in particular, to a glue frame of a display device and the display device.

2. The Related Arts

With the development of small-to-medium-size liquid crystal screen, the backlight module free of front iron frame has become one of the important directions of the product structure design. On one hand, by removing the front iron frame, the bezel of the liquid crystal display device can be made narrower and the displayer area may become larger; on the other hand, the manufacturing costs are saved.

In the design of products having a relative large size, the removal of the iron frame from the backlight module may reduce the cost significantly, but may also weaken the overall strength of the product, thus affecting the reliability of the product.

### SUMMARY

In view of the disadvantages present in the related art, the present invention provides a cost-effective and reliable glue frame and a display device.

In order to achieve the above object, the present invention adopts the following technical solutions:

A glue frame, comprising a first frame structure enclosed by a plurality of side walls, the first frame structure is injection molded integrally by the plastic cement and the metal sheet component.

Wherein the metal sheet component is provided with a plurality of grooves at the surface thereof

Or the metal sheet component is provided with a plurality of through holes at the surface thereof

Wherein the metal sheet component comprises a plurality of protection corners, each of the protection corners comprises two metal sheets connected in a way of being perpendicular to each other, and the protection corners are disposed at four corners of the first frame structure.

Wherein the plurality of protection corners are connected integrally, so as to make the metal sheet component form a frame structure.

Wherein the metal sheet component is enclosed completely in the plastic cement.

Or the metal sheet component is exposed partially outside the first frame structure.

The present invention also provides a display device, comprising the glue frame described as above, a liquid crystal panel and a backlight component, the backlight component is accommodated in the glue frame.

Wherein the metal sheet component is provided with a plurality of grooves at the surface thereof

Or the metal sheet component is provided with a plurality of through holes at the surface thereof

Wherein the metal sheet component comprises a plurality of protection corners, each of the protection corners comprises two metal sheets connected in a way of being perpendicular to each other, and the protection corners are disposed at four corners of the first frame structure.

Wherein the plurality of protection corners are connected integrally, so as to make the metal sheet component form a frame structure.

Wherein the backlight component comprises an optical film sheet, a light guide plate, a reflection sheet and a light strip component, the light strip component comprises a horizontal portion and a vertical portion which are perpendicular to each other, wherein the thickness of the horizontal portion is the same as that of the optical film sheet.

Wherein the horizontal portion and the vertical portion form a T-shaped structure, and the lower surfaces of both ends of the horizontal portion is pasted tightly on the top surface of the glue frame and the light guide plate, respectively.

When the glue frame of the present invention is applied to a display device, the iron frame can be removed, thus saving the manufacturing costs, and improving the connection performance and reliability.

### BRIEF DESCRIPTION OF DRAWINGS

FIG. 1 is a schematic view of the partial structure of the display device of the first embodiment of the present invention.

FIG. 2 is a schematic view of the structure of the glue frame of the first embodiment of the present invention.

FIG. 3a is a schematic view of the cut-away structure of the glue frame of the first embodiment of the present invention.

FIG. 3b is a schematic view of the other cut-away structure of the glue frame of the first embodiment of the present invention.

FIG. 4 is a schematic view of the structure of the metal sheet component of the glue frame of the first embodiment of the present invention.

FIG. 5 is a schematic view of the structure of the metal sheet component of the glue frame of the second embodiment of the present invention.

FIG. 6 is a schematic view of the other structure of the metal sheet component of the glue frame of the second embodiment of the present invention.

### DETAILED DESCRIPTION

In order to make the object, the technical solution and advantages of the present invention more apparent and clear, hereinafter, the present invention will be further described in detail in conjunction with accompanying drawings and embodiments. It is understood that the specific embodiments described herein are used only to explain the present invention without being used to limit the present invention.

### Embodiment 1

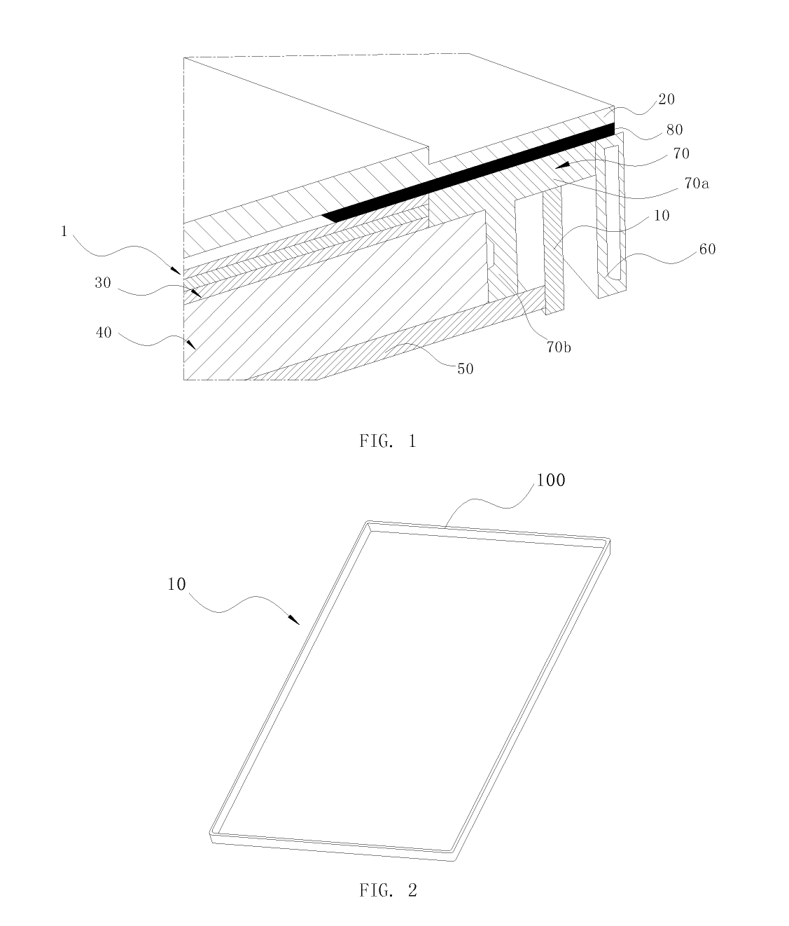

Referring to FIG. 1, the display device of the first embodiment of the present invention comprises a glue frame 10, a liquid crystal panel 20, a frame 60 and a backlight component 1, wherein the glue frame 10 is substantially a frame structure and accommodates the backlight component 1 therein. The backlight component 1 comprises an optical film sheet 30, a light guide plate 40, a reflection sheet 50 and a light strip component 70. The light strip component 70 is provided with a plurality of LED light sources (not shown in the drawing) thereon for generating the backlight beam, and comprises a horizontal portion 70a and a vertical portion 70b which are perpendicular to each other, wherein the thickness of the horizontal portion 70a is the same as that of the optical film sheet 30, and both ends of the horizontal portion 70a abut and connect with the frame 60 and the optical film sheet 30, and the upper surface of the horizontal portion 70a is pasted on the lower surface of the liquid crystal panel 20 through the light shading adhesive tape 80; the bottom of the vertical portion 70b is perpendicular to the upper surface of the reflection sheet 50 and pasted tightly thereon, and the vertical portion 70b and the horizontal portion 70a form a T-shaped structure, and the lower surfaces of both ends of the horizontal portion 70a are pasted tightly on the upper surface of the light guide plate 40 and the top surface of the glue frame 10 respectively. In particular, the optical film sheet 30, the light guide plate 40 and the reflection sheet 50 are arranged sequentially from the top to the bottom, and the liquid crystal panel 20 is pasted on the upper surface of the frame 60, the upper surface of the horizontal portion 70a of the light strip component 70 and a portion of the upper surface of the optical film sheet 30 through the light shading adhesive tape 80.

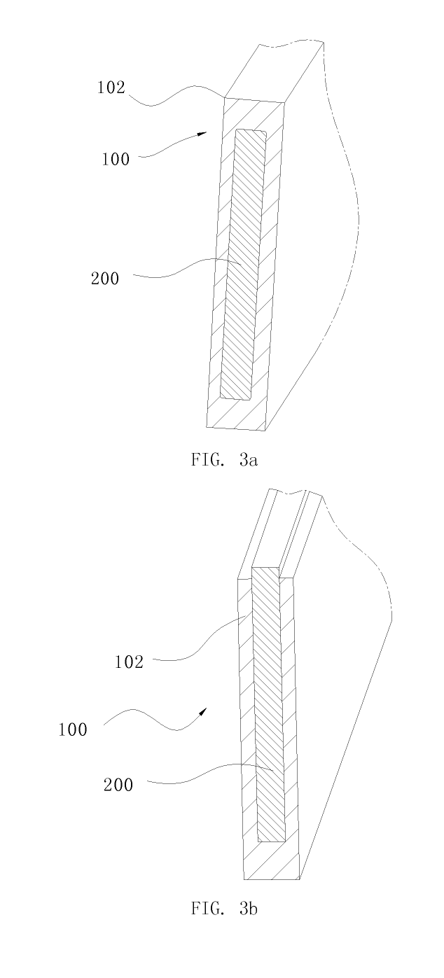

Meanwhile, in conjunction with FIG. 2 and FIG. 3a, the glue frame 10 comprises a first frame structure 100 enclosed by a plurality of side walls. The first frame structure 100 is injection molded integrally by the plastic cement 102 and the metal sheet component 200, and the engineering plastics are used as the plastic cement.

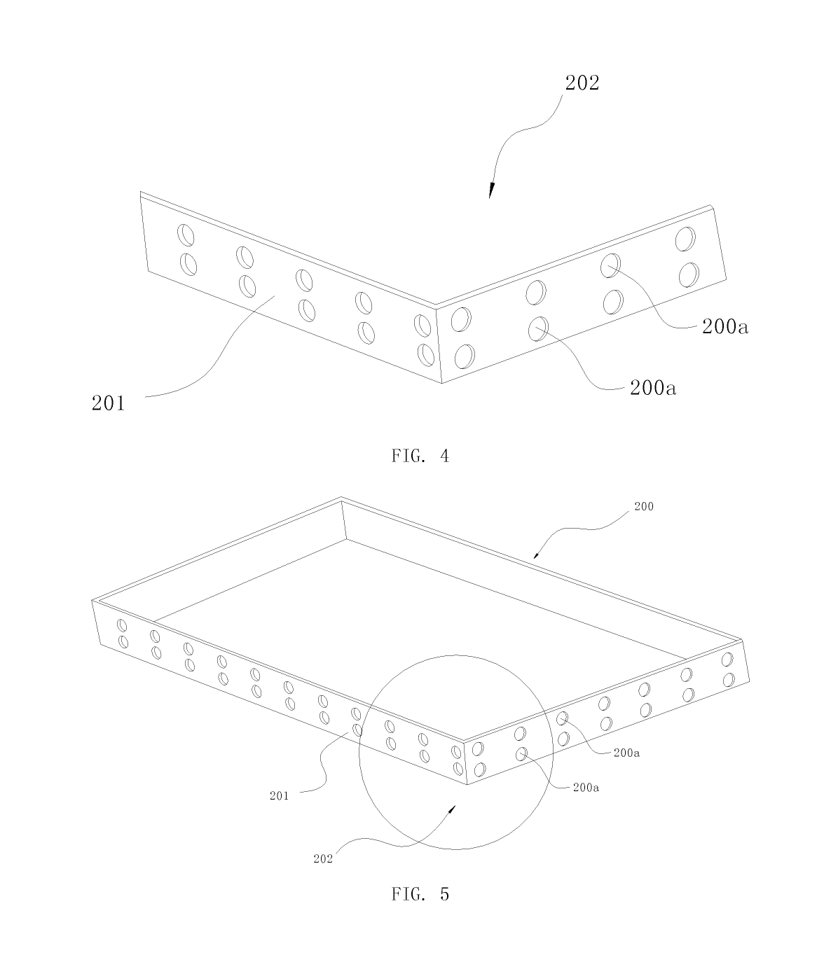

As shown in FIG. 4, in order to increase the coupling strength of the plastic cement 102 and the metal sheet component 200, the metal sheet component 200 is provided with a plurality of grooves 200a at the surface thereof so as to increase the roughness. It is understood that, the metal sheet component 200 may also be provided with a plurality of through holes at the surface thereof, and the metal sheet component 200 may also be provided with grooves and through holes at the surface thereof at the same time, which may achieve the same effect of increasing the roughness of the surface of the metal sheet component 200 and the coupling strength of injection molding.

In the present embodiment, the metal sheet component 200 comprises a plurality of protection corners 202. Each of the protection corners 202 comprises two metal sheets 201 connected in a way of being perpendicular to each other. The protection corners 202 are disposed at four corners of the first frame structure 100, for increasing the structural strength of the first frame structure 100.

In the glue frame 10, there are various ways for the injection molding the plastic cement 102 and the metal sheet component 200. FIG. 3a shows a case of the metal sheet component 200 being enclosed completely in the plastic cement 102, and various structural designs can be made at the surface of the glue frame 10 which is injection molded in such way; FIG. 3b shows the other way for injection molding, where the metal sheet component 200 being enclosed partially in the plastic cement 102, and the metal sheet component 200 being exposed partially outside the first frame structure 100.

In the specific injection molding process, the protection corners 202 formed by the metal sheets 201 connected in a way of being perpendicular to each other are disposed at four corners of the injection molded cavity corresponding to the glue frame 10, respectively, as the reinforced portions of respective corners of the glue frame 10, and then the plastic cement material is injected into the mold so as to complete the injection molding process.

Since the metal sheet component 200 is disposed at four corners of the glue frame 10 correspondingly, meanwhile, the metal sheet component 200 is provided with a plurality of grooves 200a at the surface thereof, the roughness of the surface of the metal sheet component 200 is increased, allowing the metal sheet component 200 and the plastic cement to be coupled more closely, and increasing the overall strength of the structure of the glue frame 10, as well as the reliability of the product.

### Embodiment 2

As shown in FIG. 5, the present embodiment differs from embodiment 1 as follows: the plurality of protection corners 202 of the present embodiment are connected integrally, so as to make the metal sheet component 200 forms a frame structure, thus further increasing the overall strength of the structure of the glue frame 10. In the specific injection molding process, the metal sheet component 200 similar to the glue frame 10 in shape is disposed in the glue frame 10 of the injection molded cavity, as the framework of the glue frame 10, and then the plastic cement material is injected into the mold so as to complete the injection molding process.

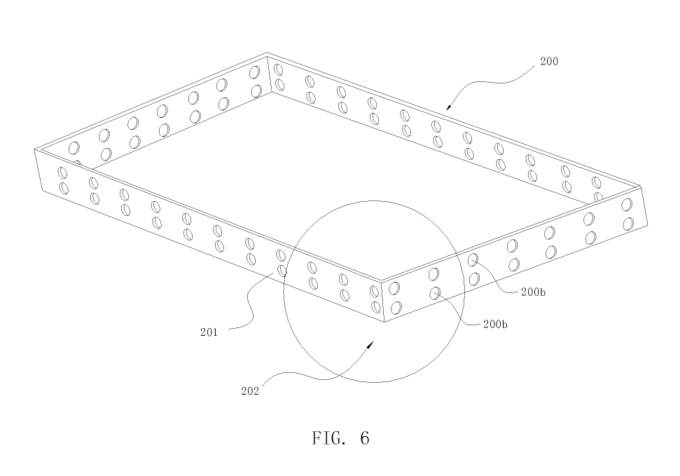

FIG. 6 is a schematic view of the other structure of the metal sheet component 200 of the glue frame 10 of the present embodiment. The metal sheet component 200 is provided with a plurality of through holes 200b at the surface thereof, which may also achieve the effect of increasing the roughness of the surface of the metal sheet component 200 and the coupling strength of injection molding by using the previous structure of the metal sheet component 200. It can be understood that, the metal sheet component 200 may also be provided with grooves 200a and through holes 200b at the surface thereof at the same time.

What described as above are the specific embodiments of the present application only. It is pointed out that, it can be made various improvements and modifications for those ordinary skilled in the art without departing the principle of the present application, and these improvements and modifications are also considered as the protection scope of the present application.

What is claimed is:

1. A glue frame, comprising a first frame structure enclosed by a plurality of side walls, the first frame structure is injection molded integrally by the plastic cement and the metal sheet component.

2. The glue frame according to claim 1, wherein the metal sheet component is provided with a plurality of grooves at the surface thereof.

3. The glue frame according to claim 1, wherein the metal sheet component is provided with a plurality of through holes at the surface thereof.

4. The glue frame according to claim 2, wherein the metal sheet component comprises a plurality of protection corners, each of the protection corners comprises two metal sheets connected in a way of being perpendicular to each other, and the protection corners are disposed at four corners of the first frame structure.

5. The glue frame according to claim 4, wherein the plurality of protection corners are connected integrally, so as to make the metal sheet component form a frame structure.

6. The glue frame according to claim 5, wherein the metal sheet component is enclosed completely in the plastic cement.

7. The glue frame according to claim 5, wherein the metal sheet component is exposed partially outside the first frame structure.

8. The glue frame according to claim 3, wherein the metal sheet component comprises a plurality of protection corners, each of the protection corners comprises two metal sheets connected in a way of being perpendicular to each other, and the protection corners are disposed at four corners of the first frame structure.

9. The glue frame according to claim 8, wherein the plurality of protection corners are connected integrally, so as to make the metal sheet component form a frame structure.

10. The glue frame according to claim 9, wherein the metal sheet component is enclosed completely in the plastic cement.

11. The glue frame according to claim 9, wherein the metal sheet component is exposed partially outside the first frame structure.

12. A display device, comprising the glue frame according to claim 1, a liquid crystal panel and a backlight component, the backlight component is accommodated in the glue frame.

13. The display device according to claim 12, wherein the metal sheet component is provided with a plurality of grooves at the surface thereof.

14. The display device according to claim 13, wherein the metal sheet component comprises a plurality of protection corners, each of the protection corners comprises two metal sheets connected in a way of being perpendicular to each other, and the protection corners are disposed at four corners of the first frame structure.

15. The display device according to claim 14, wherein the plurality of protection corners are connected integrally, so as to make the metal sheet component form a frame structure.

16. The display device according to claim 12, wherein the metal sheet component is provided with a plurality of through holes at the surface thereof.

17. The display device according to claim 16, wherein the metal sheet component comprises a plurality of protection corners, each of the protection corners comprises two metal sheets connected in a way of being perpendicular to each other, and the protection corners are disposed at four corners of the first frame structure.

18. The display device according to claim 17, wherein the plurality of protection corners are connected integrally, so as to make the metal sheet component form a frame structure.

19. The display device according to claim 12, wherein the backlight component comprises an optical film sheet, a light guide plate, a reflection sheet and a light strip component, the light strip component comprises a horizontal portion and a vertical portion which are perpendicular to each other, wherein the thickness of the horizontal portion is the same as that of the optical film sheet.

20. The display device according to claim 19, wherein the horizontal portion and the vertical portion form a T-shaped structure, and the lower surfaces of both ends of the horizontal portion is pasted tightly on the top surface of the glue frame and the light guide plate, respectively.
